(19) United States
(12) Patent Application Publication
(10) Pub. No.: US 2016/0210698 A1
(43) Pub. Date: Jul. 21, 2016

(54) INSURANCE APPLICATION SYSTEM, INSURANCE APPLICATION METHOD, PROGRAM, AND INFORMATION STORAGE MEDIUM

(71) Applicant: RAKUTEN, INC., Tokyo (JP)

(72) Inventor: Kento UEDA, Tokyo (JP)

(73) Assignee: RAKUTEN, INC., Tokyo (JP)

(21) Appl. No.: 14/908,610

(22) PCT Filed: Jul. 31, 2013
(86) PCT No.: PCT/JP2013/070760

§ 371 Date: Jan. 29, 2016

(51) Int. Cl. G06Q 40/08

(52) U.S. Cl. CPC G06Q 40/08

(57) ABSTRACT

A more appropriate text of a reminder e-mail to be sent to a user who interrupts an input operation is provided in order to prompt the user to resume the input operation. An insurance application system sequentially presents a plurality of input screens, each having input items and being presented to an applicant, and stores, in association with the applicant, input status information indicating the input screen in which the applicant has entered information and a date and a time on which the applicant entered the information, based on information that the applicant has entered in one of the input screens. The insurance application system sends, in a case where a remind time period has passed since a date and a time on which the applicant last entered information in one of the input screens, an e-mail including a reminder e-mail text according to a template text associated with the last input screen entered by the applicant, to an e-mail address of the applicant, based on the input status information and the date and the time associated with the applicant.

### TECHNICAL FIELD

The present invention relates to an insurance application system, an insurance application method, a program, and an information storage medium.

### BACKGROUND ART

There are Web sites that enable users to apply for an insurance using the Internet. When applying for insurance, a user inputs information about a policyholder and an insured person, confirmation of intention, nonmedical report, and a payment method, for example. At this time, the user sometimes needs to view ten or more pages of screens, and enter information into forms arranged on the screens. As such, enormous amount of work needs to be done for reviewing and inputting operation, and thus the user sometimes interrupts the operation in order to check hospital visit record for declaring health condition, which is included in the nonmedical report, or to consult with the family for a payment method. In such a case, it is not unusual that the input operation is interrupted and the remaining operation is not restarted for several days. In an attempt to prompt the user to proceed with the application, some insurance companies send reminder e-mails after a predetermined period (e.g., one week) has passed since the user interrupted the input operation.

Patent Literature 1 describes sending a support mail that includes an advice text according to a learner's learning progress.

### CITATION LIST

### Patent Document

Patent Literature 1: JP2003-150029A

### SUMMARY OF INVENTION

### Technical Problem

Sometimes a text in a reminder e-mail sent to a user who has interrupted an input operation is not appropriate for prompting the user to proceed with the operation. Practically, messages appropriate for the reminder e-mail vary depending on how far the input operation has progressed or where the user was interrupted in the operation. For example, if the operation is interrupted at the time of inputting information about a policyholder and an insured person, it is necessary to ask the user if they really need to apply for insurance to begin with. If the operation is interrupted at the time of inputting a payment method, it is not necessary to ask such question, but to prompt the user to finish the input operation.

One or more embodiments of the present invention have been conceived in view of the above, and an object thereof is to provide an appropriate text of a reminder e-mail sent to a user who has interrupted an input operation in order to prompt the user to proceed with the operation.

### Solution to Problem

In order to solve the above described problems, an insurance application system according to the present invention includes input screen presenting means for sequentially present a plurality of input screens, each having input items and being presented to an applicant, obtaining means for obtaining information entered by the applicant in one of the input screens, input status storing means for storing, in association with the applicant, input status information indicating an input screen, which is one of the input screens and in which the applicant has entered information, and a date and a time on which the applicant entered the information, based on the obtained information, and remind means for sending, in a case where a remind time period has passed since a date and a time on which the applicant last entered information in one of the input screens, an e-mail including a reminder e-mail text according to a template text associated with the last input screen entered by the applicant, to an e-mail address of the applicant, based on the input status information and the date and the time associated with the applicant.

An insurance application method according to the present invention includes sequentially presenting a plurality of input screens, each having input items and being presented to an applicant, obtaining information entered by the applicant in one of the input screens, storing, in association with the applicant, input status information indicating an input screen, which is one of the input screens and in which the applicant has entered information, and a date and a time on which the applicant entered the information, based on the obtained information, and sending, in a case where a remind time period has passed since a date and a time on which the applicant last entered information in one of the input screens, an e-mail including a reminder e-mail text according to a template text associated with the last input screen entered by the applicant, to an e-mail address of the applicant, based on the input status information and the date and the time associated with the applicant.

A program according to the present invention causes a computer to execute sequentially presenting a plurality of input screens, each having input items and being presented to an applicant, obtaining information entered by the applicant in one of the input screens, storing, in association with the applicant, input status information indicating an input screen, which is one of the input screens and in which the applicant has entered information, and a date and a time on which the applicant entered the information, based on the obtained information, and sending, in a case where a remind time period has passed since a date and a time on which the applicant last entered information in one of the input screens, an e-mail including a reminder e-mail text according to a template text associated with the last input screen entered by the applicant, to an e-mail address of the applicant, based on the input status information and the date and the time associated with the applicant.

A computer-readable information storage medium according to the present invention stores the program described above.

According to the present invention, it is possible to generate a more appropriate text of a reminder e-mail to be sent to a user who interrupts an input operation in order to prompt the user to resume the input operation.

In an embodiment of the present invention, the remind means may send the e-mail including the reminder e-mail text to the e-mail address of the applicant in a case where a remind time period associated with the input screen, in which the applicant last entered information, has passed since the date and the time on which the applicant last entered information in the input screen.

According to this embodiment, it is possible to send a reminder e-mail to a user at a timing that allows the user to easily resume the input operation.

In an embodiment of the present invention, the remind means may obtain information indicating an input speed of the applicant based on a time on which the applicant enters information in each of the input screens, generate the reminder e-mail text further based on the information indicating the input speed, and send the e-mail including the generated reminder e-mail text to the e-mail address of the applicant.

According to this embodiment, it is possible to more accurately present to the user a time required for the user to resume the input operation.

### BRIEF DESCRIPTION OF DRAWINGS

FIG. 1 is a diagram illustrating an example of configuration of an insurance application system according to an embodiment of the present invention.

FIG. 2 is a diagram illustrating an example of a hardware configuration of an insurance application server.

FIG. 3 is a functional block diagram showing functions implemented by the insurance application server.

FIG. 4 is a diagram illustrating an example of types of screens used for applying for insurance.

FIG. 5 is a diagram illustrating an example of a processing flow chart of an estimate unit.

FIG. 6 is a diagram illustrating an example of an estimate detail screen.

FIG. 7 is a diagram illustrating an example of a processing flow chart when a user enters information in an input screen.

FIG. 8 is a diagram illustrating an example of user information.

FIG. 9 is a diagram illustrating an example of a first health condition input screen.

FIG. 10 is a diagram illustrating an example of application information.

FIG. 11 is a diagram illustrating an example of a processing flow chart of a reminder e-mail sending unit.

FIG. 12 is a diagram illustrating an example of e-mail setting information.

FIG. 13 illustrates an example of a reminder e-mail text.

FIG. 14 illustrates another example of a reminder e-mail text.

FIG. 15 is a diagram illustrating an example of an input resuming screen.

### DESCRIPTION OF EMBODIMENTS

In the following, an embodiment of the present invention will be described in detail with reference to the accompanying drawings. Regarding the elements designated with the same numerals, their overlapping explanation will be omitted. If not otherwise stated, the following explains a case of applying for life insurance on the Internet. However, the same processing can be applied to services provided when applying for other insurance, such as property insurance, on the Internet.

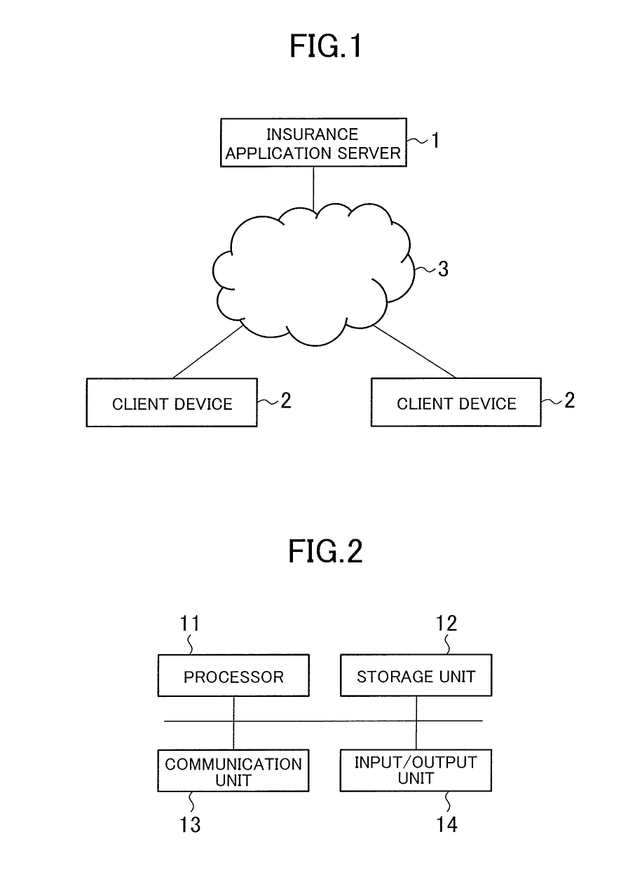

FIG. 1 illustrates an example of an insurance application system according to an embodiment of the present invention. The insurance application system includes an insurance application server 1 and client devices 2, which are connected to one another via a network 3. The network 3 is, for example, a local area network or the Internet.

The insurance application server 1 is a server computer. The insurance application server 1 obtains information from a database, for example, in response to a request from a client device 2, and sends the obtained information to the client device 2. The client device 2 is a computer, such as a smartphone and a personal computer. Here, the insurance application server 1 executes a web server program (e.g., httpd), for example, and a request input by the user using the client device 2, which executes a browser program, is sent to the insurance application server 1. Then, a screen corresponding to information sent from the insurance application server 1 is presented to the user.

FIG. 2 illustrates an example of a hardware configuration of the insurance application server 1. The insurance application server 1 includes a processor 11, a storage unit 12, a communication unit 13, and an input/output unit 14.

The processor 11 operates according to programs stored in the storage unit 12. The processor 11 controls the communication unit 13 and the input/output unit 14. The programs may be provided via the Internet or by being stored in a computer-readable storage medium such as a flash memory or a DVD-ROM.

The storage unit 12 includes a memory device such as a RAM or a flash memory, and a hard disk drive. The storage unit 12 stores the programs. In addition, the storage unit 12 stores information from each unit and computational result input.

The communication unit 13 implements functions to communicate with other devices, and includes, for example, an integrated circuit of a wired LAN and a connector, and an integrated circuit of a wireless LAN and an antenna. The communication unit inputs information received from other devices into the processor 11 and the storage unit 12, and sends information to other devices under the control of the processor 11.

The input/output unit 14 includes a video controller for controlling display output means, and a controller for obtaining data from an input device. The input device includes a keyboard, a mouse, and a touch panel. The input/output unit 14 outputs display data to the display output device under the control of the processor 11, and obtains data, which is entered when the user operates the input device. The display output device is, for example, a display device connected to the outside. Similarly to the insurance application server 1, the client device 2 also includes a processor, a storage unit, a communication unit, and an input/output unit. The input/output unit included in the client device 2 outputs display data to, for example, a display provided to a smartphone.

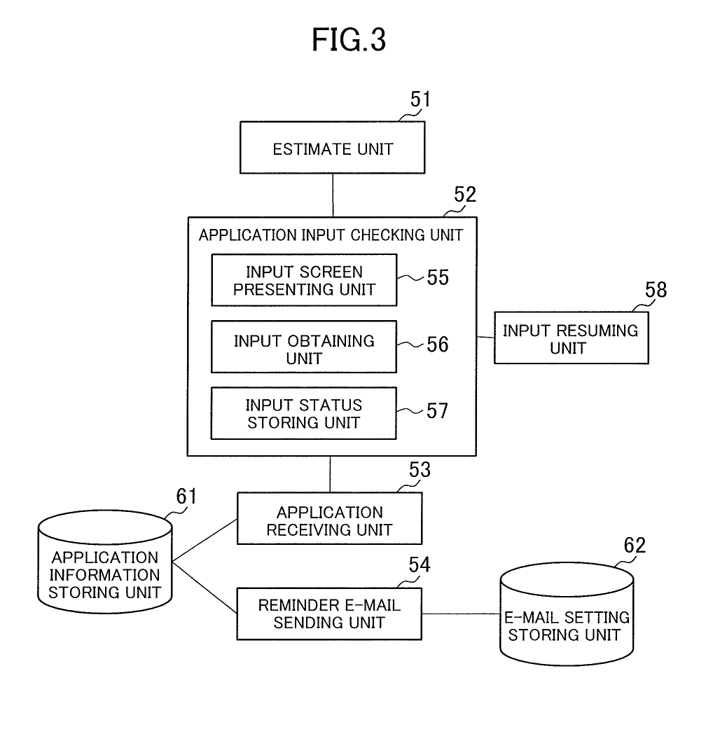

FIG. 3 is a functional block diagram showing functions implemented by the insurance application server 1. The insurance application server functionally includes an estimate unit 51, an application input checking unit 52, an application receiving unit 53, a reminder e-mail sending unit 54, an input resuming unit 58, an application information storing unit 61, and an e-mail setting storing unit 62. Further, the application input checking unit 52 functionally includes an input screen presenting unit 55, and input obtaining unit 56, and an input status storing unit 57. These function are implemented by the processor 11 included in the insurance application server 1 executing a program stored in the storage unit 12 and controlling the communication unit 13, for example.

The application information storing unit 61 is a database for storing, for example, information of a policyholder (user) (policyholder information) entered by the user, information of an insurance plan for which the user applies, and nonmedical information. The e-mail setting storing unit 62 is a database for storing, for example, e-mail setting information and e-mail text. The application information storing unit 61 and the e-mail setting storing unit 62 are each implemented mainly by the storage unit 12 of the insurance application server 1, although may be implemented by other server computer that is independent from the insurance application server 1 and a database program runs thereon.

The client device 2 executes a browser program, outputs images to the display output device based on the data received from the insurance application server 1, and presents information to the user. The client device 2 sends information entered by the user with a touch panel or a keyboard to the insurance application server 1.

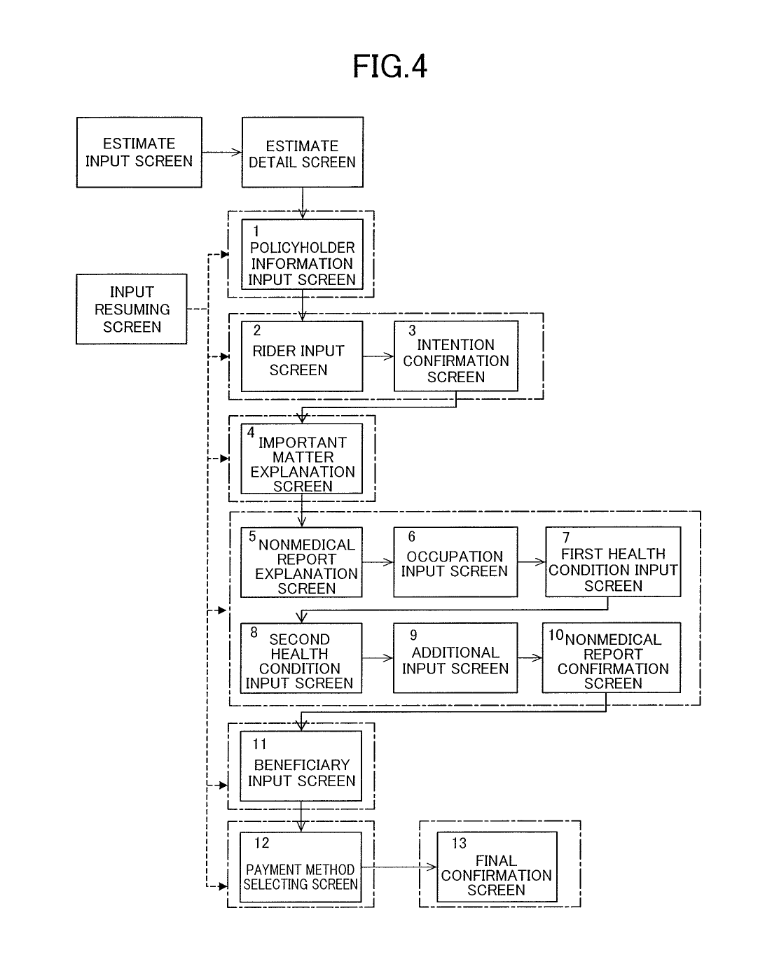

FIG. 4 illustrates an example of types of screens used for applying for insurance. In FIG. 4, rectangles with solid lines show screens that are output by the insurance application server 1 at the time when the insurance is applied, and arrows with solid lines indicate screen transitions when the user continues to input without revising content entered in the previous screen. An estimate input screen and an estimate detail screen are screens used for presenting or proposing insurance products to a user before the user starts application procedure, and the estimate unit 51 executes proceeding relating these screens. When the user starts applying for insurance on the estimate detail screen, the application input checking unit 52 performs application input processing by using thirteen screens starting from a policyholder information input screen to a final confirmation screen in order. In FIG. 4, sequential numbers are respectively described in upper left corners of rectangles of input screens. The screens used for the application input processing are divided into seven groups depending on kind of content entered or confirmed on each screen. In FIG. 4, dot-and-dash lines surrounding one or more screens respectively represent the groups.

In a case where a user who applies for insurance on a Web site, the user is made to start input operations on the estimate input screen. When the user presses a button for confirming the application for the insurance on the final confirmation screen, the operations for applying for the insurance on this Web site are finished. In a case where the user completes input in some screens and stops input in subsequent screens, the user can later resume the operation for applying for the insurance, via an input resuming screen, on a screen subsequent to the screen on which the input is finished. The arrows with dashed lines show screen transitions at the time when the input is restarted. In FIG. 4, the arrows with dashed lines are directed to the screen groups, although they actually move to an input screen subsequent to the input screen where the user has completed the input.

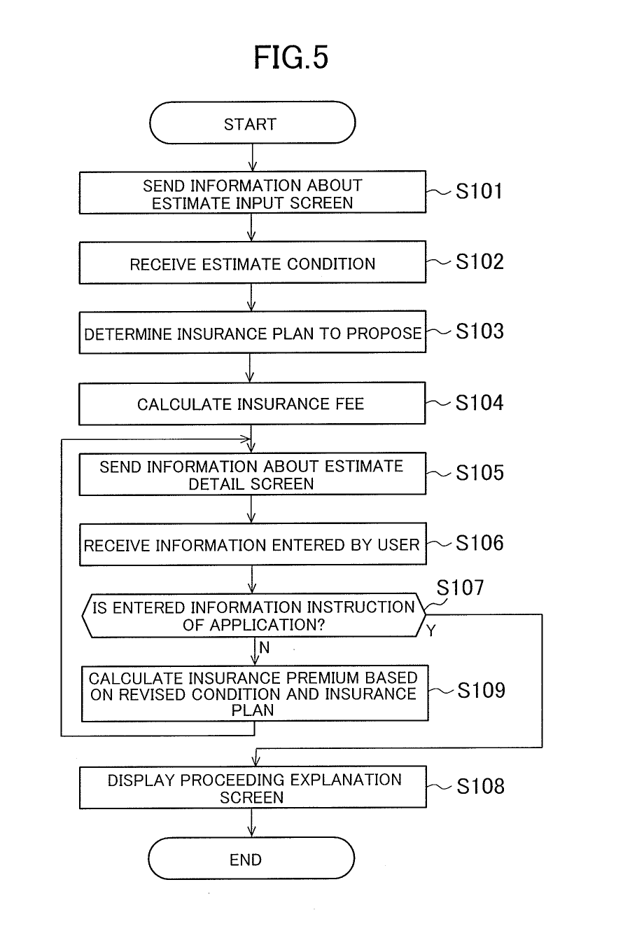

Next, processing relating to each screen will be discussed. FIG. 5 is an example of a processing flow chart of the estimate unit 51. The estimate unit 51 is implemented mainly by the processor 11, the storage unit 12, and the communication unit 13, and presents an insurance plan according to estimate conditions entered by the user. The estimate unit 51 first sends information about the estimate input screen to a client device 2 operated by a user who accesses the insurance application server 1 (Step S101). In this regard, information about each screen is HTML data, and such information includes information about a script for the client device 2 to execute.

The estimate input screen is a screen in which estimate conditions are entered, and includes areas in which a user enters estimate conditions, such as the user's family structure, whether the user has applied for insurance or not, which of an insurance premium and an insurance amount is given priority for the life insurance, gender, and date of birth. When the estimate conditions are entered in these areas on the estimate input screen, the client device 2 that executes the script included in the information of the estimate input screen sends the estimate conditions to the insurance application server 1.

The estimate unit 51 receives the estimate conditions sent from the client device 2 (Step S102). The estimate unit 51 then determines an insurance plan to propose according to the received estimate conditions (Step S103), and calculates an insurance premium based on the determined insurance plan and the estimate conditions (Step S104). Subsequently, the estimate unit 51 sends information of the estimate detail screen, which includes information about the determined insurance plan and the calculated insurance premium, to the client device 2 (Step S105).

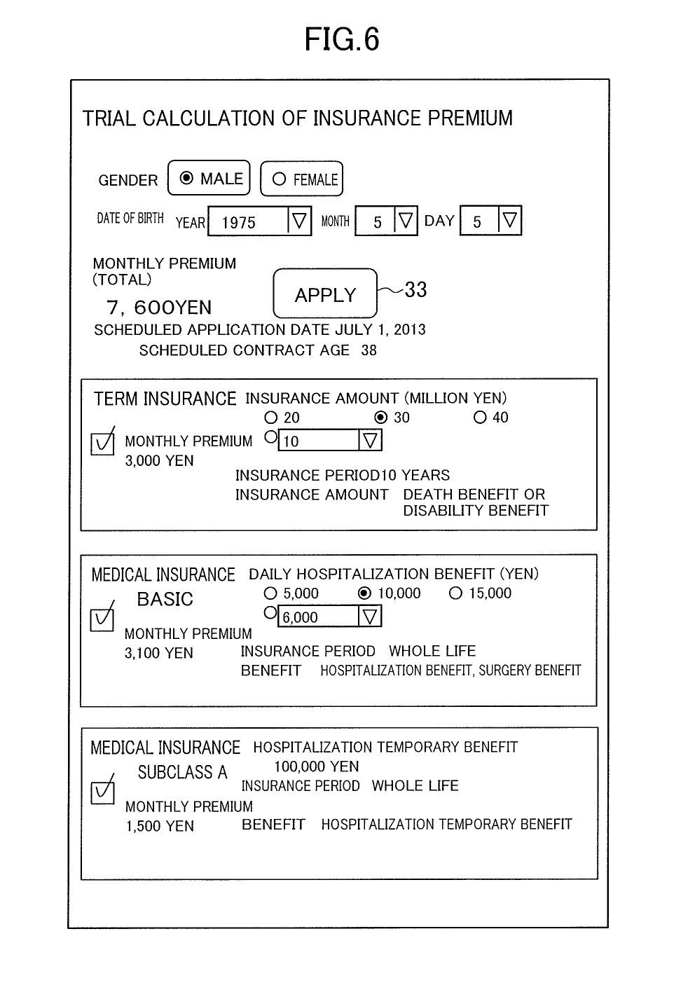

FIG. 6 illustrates an example of the estimate detail screen. The estimate detail screen displays an insurance plan and an insurance premium for the insurance plan. The estimate detail screen has input areas for correcting the gender and the date of birth, and an applying button 33 for starting procedure to apply for insurance when the user accepts the insurance plan. The estimate detail screen displays sections for some products of life insurance as insurance plans, and each section includes an product's name, a check box for selecting whether to set the product to a target of estimate and application, an area for inputting, for example, an insurance amount of the product, and an area for an outline of the product. In addition, the estimate detail screen has sections for displaying insurance premiums of respective products, which are calculated based on the user's date of birth, for example, and a total of these insurance premiums.

When the user performs any input operation on the estimate detail screen, the client device 2 sends information entered by the user. Subsequently, the estimate unit 51 receives the information entered by the user (Step S106), and if the entered information indicates that the user has pressed the applying button 33 (instruction of application) (Y in Step S107), the estimate unit 51 causes the application input checking unit 52 to start processing for displaying an initial input screen (policyholder information input screen) (Step S108). On the other hand, if the entered information is not an instruction to apply for insurance, the estimate unit 51 calculates insurance premiums based on the entered information (e.g., date of birth or revised insurance amount) (Step S109), moves to the processing of Step S105 for sending information of the estimate detail screen, and repeats subsequent processing.

The application input checking unit 52 is implemented mainly by the processor 11, the storage unit 12, and the communication unit 13. The application input checking unit 52 sequentially presents some input screens to a user who applies for insurance, obtains information entered in the presented input screens, and causes the application information storing unit 61 to store the obtained information. In the following, processing of the application input checking unit 52 and the units included therein, i.e., the input screen presenting unit 55, the input obtaining unit 56, and the input status storing unit 57 will be discussed.

The input screen presenting unit 55 sequentially presents a plurality of input screens to the user. When the user presses the applying button 33 on the estimate detail screen, the input screen presenting unit 55 sends information about a first input screen (policyholder information input screen) to the client device 2 of the user, and also sends subsequent input screens to the client device 2 of the user in response to user inputs. Further, the input obtaining unit 56 obtains information entered by the user in the presented input screen, and the input status storing unit 57 causes the application information storing unit 61 to store information entered by the user and the date of the input in association with the user.

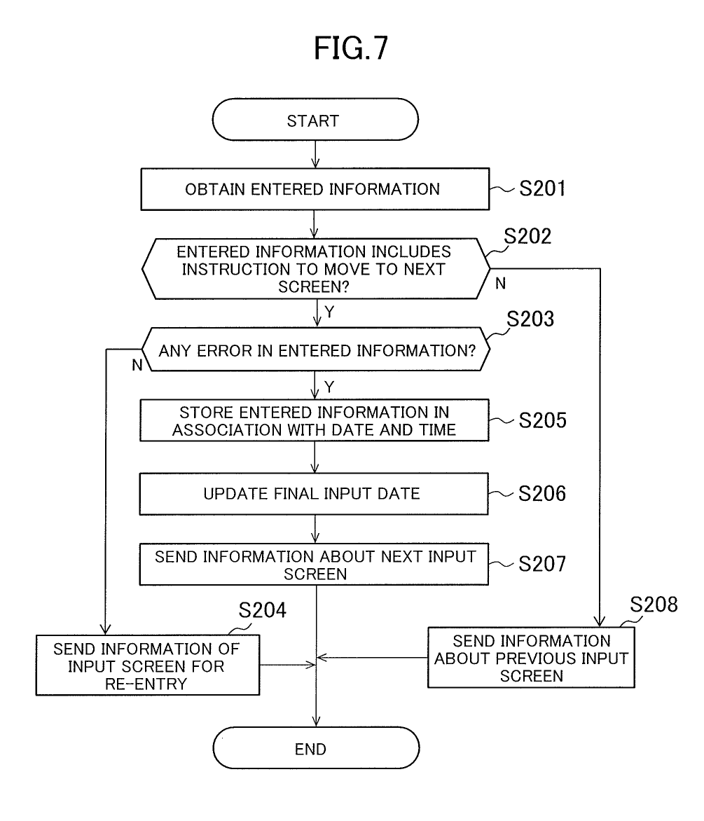

In the following, the processing will be discussed in a case where the input screen presenting unit 55 sends information about an input screen, and, after the input screen is displayed on the client device 2, the user enters information in the input screen. FIG. 7 illustrates an example of a processing flow chart when the user enters information on an input screen.

First, the input obtaining unit 56 obtains information entered by the user on the displayed input screen (Step S201). If the entered information includes an instruction to move to the next screen (Y in Step S202), the input status storing unit 57 checks, for information entered in input forms and check boxes, if there is any required item that is not entered or any error, such as contradiction between the entered information items (Step S203). If the required item is not yet entered or includes an error (N in Step S203), the input status storing unit 57 sends information of the same screen as the current input screen for re-entry (Step S204). On the other hand, if all the required items are entered and include no error (Y in Step S203), the input status storing unit 57 stores information about the entered item into the application information storing unit 61 by associating the date and time (current date and time) when the item is entered with the user (Step S205). Further, the input status storing unit 57 stores or updates the final input date, which is stored in the application information storing unit 61 in association with the user (Step S206). The final input date is newly stored at the time when information is entered on the first input screen, and updated thereafter. The input screen presenting unit 55 then sends, if there is a next input screen, information about such input screen (Step S207). In a case where the processing of the input obtaining unit 56 and the input status storing unit 57 is performed with respect to the final confirmation screen, which is the final input screen, the application receiving unit 53 performs the processing for receiving an application, instead of Step S207, and the application receiving unit 53 sends information about the screen indicating that the application is received. In Step S202, if the information does not include an instruction to move to the next screen (N in Step S202), assuming that the information includes an instruction to move to the previous screen, the input screen presenting unit 55 sends information about the previous input screen (Step S208).

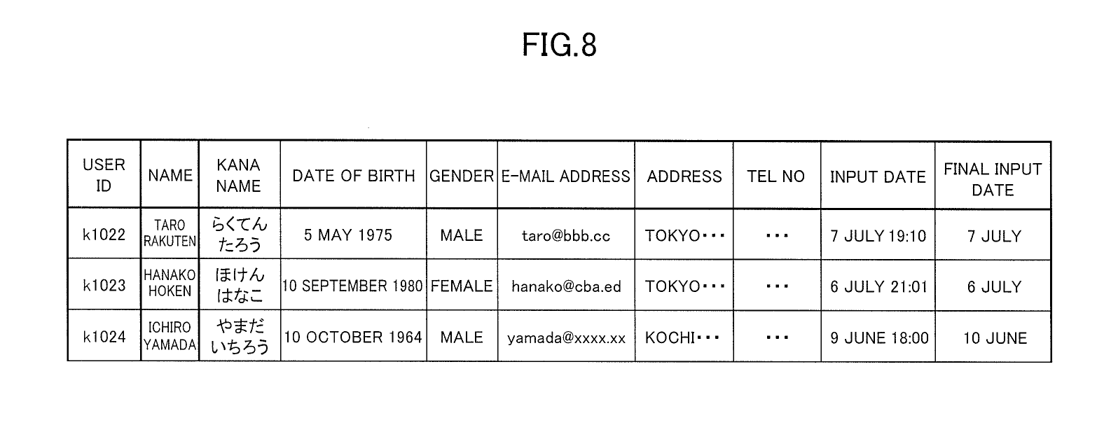

FIG. 8 illustrates an example of user information stored in the application information storing unit 61. The user information is also policyholder information of a user who applies for insurance. The user information includes an user ID for specifying the user, an e-mail address, information about the user's attribute, such as name, date of birth, and address, an input date and time when the information is entered, and a date when information is last entered in the input screen (final input date). The input status storing unit 57 causes the application information storing unit 61 to store, as user information, the information entered by the user in the policyholder information input screen.

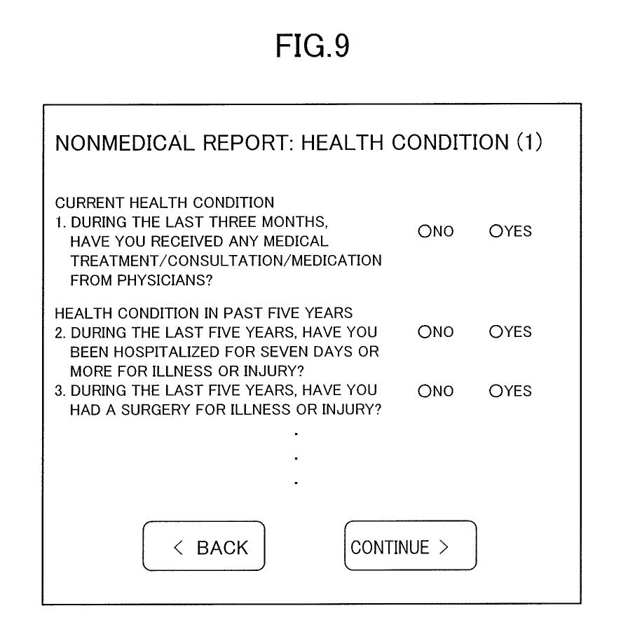

FIG. 9 illustrates an example of the first health condition input screen. The first health condition input screen is a screen for a user to enter information related to the health condition which is included in the nonmedical report required at the time of applying for life insurance. FIG. 9 shows three items to input, although a user practically inputs more than ten items. When the user presses a “Continue” button, the client device 2 sends information about an instruction, which indicates that the user enters information in the input screen and moves to the next input screen, and information about the entered item. On the other hand, when the user presses a “Back” button, the client device 2 sends information about an instruction indicates that the user returns to the previous input screen.

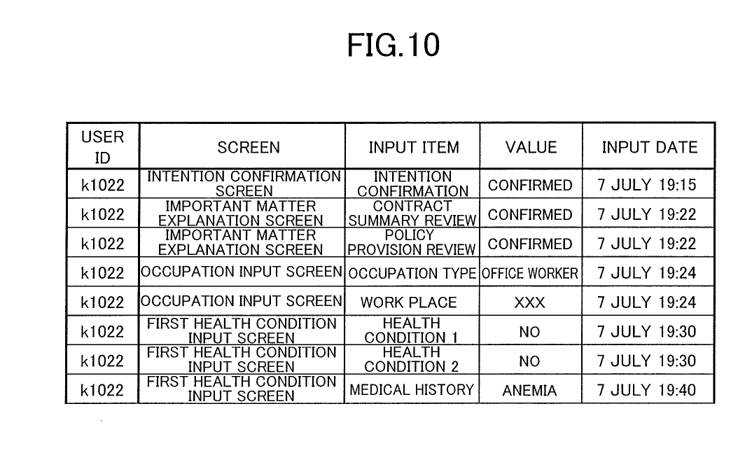

FIG. 10 illustrates an example of application information stored in the application information storing unit 61. The application information is information regarding an application of insurance other than user information, and includes information about a plan (product) of insurance that the user applies for, and information about the nonmedical report. The application information includes a plurality of input items of a user, and stores values of the respective input items. Further, the application information stores a date and time (input date and time) when information is entered for each input item. In the example of FIG. 10, the application information for a user includes a plurality of records, and the records respectively correspond to input items. Further, each input item is attached with information about a screen for inputting such input item. The application information is not limited to information that a user enters in an input form, a radio button and the like. The application information also includes information indicating that the user has confirmed, for example, explanation of important matters displayed on the input screen, and then pressed a button to continue the input operations.

Here, the user information and the application information stored in the application information storing unit 61 is information entered by the user in items on the input screen, for example. Such information also indicates an input status to which input screen the user has proceeded and finished input operations. It is possible to determine to which input screen the user has proceeded and finished entry by checking which input item's value has already been stored in the application information storing unit 61.

The application information may not necessarily be a form as shown in FIG. 10. For example, the form may include one record for each user, and list values of each input item. In this case, an input date and time may be stored in application information for each input screen. The input status storing unit 57 may divide the application information into information of an insurance product the user applies for and information of the nonmedical report, and store the divided information in the application information storing unit 61.

The application receiving unit 53 is implemented mainly by the processor 11, the storage unit 12, and the communication unit 13. When a user presses an “Apply” button on the final confirmation screen to confirm an application for the insurance, the application receiving unit 53 sends the user's information stored in the application information storing unit 61 to a core function processing system, which is a system for processing an application for insurance. The core function processing system informs an appropriate person at the insurance company of the application, and continues the subsequent processing, such as examination of content of the application.

The following will discuss processing of the insurance application system in a case where a user interrupts an input operation on input screens. The reminder e-mail sending unit 54 is implemented mainly by the processor 11, the storage unit 12, and the communication unit 13. When a condition regarding a remind time period is satisfied for a user, the reminder e-mail sending unit 54 sends, to the user's e-mail address, an e-mail including a text according to a template text associated with the last input screen in which the user makes entries. The condition regarding remind time period indicates that a remind time period has passed since the final input date and time stored in association with the user. The remind time period may be determined based on the last input screen entered by the user. The reminder e-mail sending unit 54 may obtain information indicating the user's input speed based on the time when the user input information on each input screen, and generate a reminder e-mail text further based on information indicating such speed. In the following, such processing will be discussed in detail.

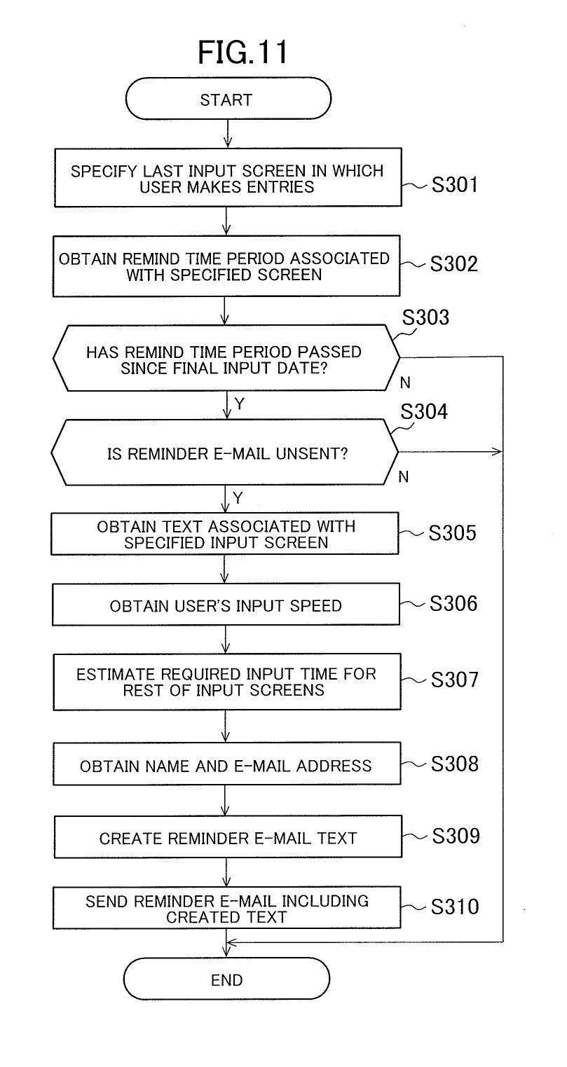

FIG. 11 illustrates an example of a processing flow chart of the reminder e-mail sending unit 54. The processing flow chart in FIG. 11 is processing with respect to a certain user. Practically, the processing shown in FIG. 11 is executed on a daily basis for all of the users who interrupt input operations in the middle.

First, the reminder e-mail sending unit 54 specifies the input screen in which the user last makes entries (Step S301). More specifically, the reminder e-mail sending unit 54 obtains a list of entered input items and input screens having such entered input items from application information and user information stored in the application information storing unit 61, and specifies the input screen that is the last in the list as the input screen last entered by the user. Subsequently, the reminder e-mail sending unit 54 obtains a remind time period and a day-of-week condition (if set in advance) associated with the specified input screen from the e-mail setting storing unit 62 that stores e-mail setting information (Step S302).

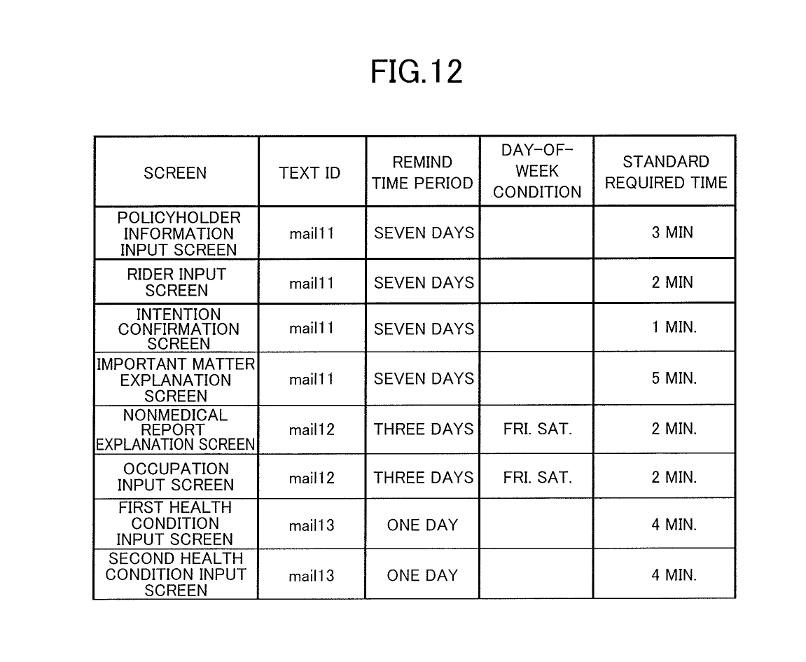

FIG. 12 illustrates an example of e-mail setting information stored in the e-mail setting storing unit 62. The e-mail setting information includes a text ID indicating an e-mail template text associated with an input screen, a remind time period and a day-of-week condition, which indicate a timing at which an e-mail associated with the input screen is sent, and a standard required time, which is a time required for a typical user to enter information in the input screen. The remind time period indicates a time interval between a point of time when the user makes entries in the input screen and a point of time when an e-mail is sent. The day-of-week condition indicates a day of the week on which a reminder e-mail may be sent.

Upon obtaining the remind time period and the like, the reminder e-mail sending unit 54 determines whether the remind time period has passed since the final input date (Step S303). More strictly speaking, the reminder e-mail sending unit 54 determines, on the day on which the processing is executed (processing date), whether the remind time period has passed since the final input date. If the day-of-week condition is designated, the reminder e-mail sending unit 54 determines whether the processing date and the final input date are separated by the remind time period or more and the day of the week of the processing is the day of the week indicated in the day-of-week condition.

If it is determined that the above described condition is satisfied (Y in Step S303), the reminder e-mail sending unit 54 determines whether a reminder e-mail is unsent for the user (Step S304). If the reminder e-mail is unsent (Y in Step S304), the reminder e-mail sending unit 54 performs processing for sending the reminder e-mail in Steps S305 to S310. In a case where the day-of-week condition is not designated, the reminder e-mail is sent on a day when the remind time period has passed since the final input date.

The processing for sending reminder e-mails will be discussed in further detail. First, the reminder e-mail sending unit 54 obtains a text associated with the specified input screen (Step S305). Next, the reminder e-mail sending unit 54 obtains the user's input speed using an input time of each input screen from user information and application information (Step S306). More specifically, regarding an input screen that is obtained from, for example, application information and belongs to a list of input screens in which the user has made entries, the reminder e-mail sending unit 54 obtains a difference between an input time of the input screen and an input time of an input screen immediately before the input screen as an required input time for the input screen. Subsequently, the reminder e-mail sending unit 54 obtains, for each input screen, a ratio of a required input time to a standard required time associated with the input screen. The reminder e-mail sending unit 54 then calculates an average value of ratios that are less than a threshold value among ratios of the input screens as the user's input speed. Here, a threshold value is used in order to avoid calculating the user's input speed unrealistically slow in a case where, for example, something has interrupted the user's input operation and taken much time.

The reminder e-mail sending unit 54 estimates a required input time for the rest of the input screens based on the user's input speed (Step S307). More specifically, the reminder e-mail sending unit 54 obtains the estimated required input time by multiplying the sum of standard required times of input screens, for which the user has not finished entries, by the calculated ratio.

Subsequently, the reminder e-mail sending unit 54 obtains the user's name and e-mail address from user information (Step S308). The reminder e-mail sending unit 54 may not need to obtain the e-mail address and the name from the information entered in the input screen at the time of the application. If the insurance application system operates in cooperation with other user authentication system and a user enters information in an input screen after logging in to the user authentication system, the reminder e-mail sending unit 54 may specify the log-in user by the user ID of the user authentication system, and obtain information such as an e-mail address associated with the user ID from the user authentication system.

Further, the reminder e-mail sending unit 54 creates a reminder e-mail text to send with use of a template text associated with the specified input screen, more specifically, with use of a template text having a text ID associated with the specified input screen, the obtained name, and the estimated required input time (Step S309).

After creating the reminder e-mail text, the reminder e-mail sending unit 54 sends a reminder e-mail including the created text to the user's e-mail address (Step S310).

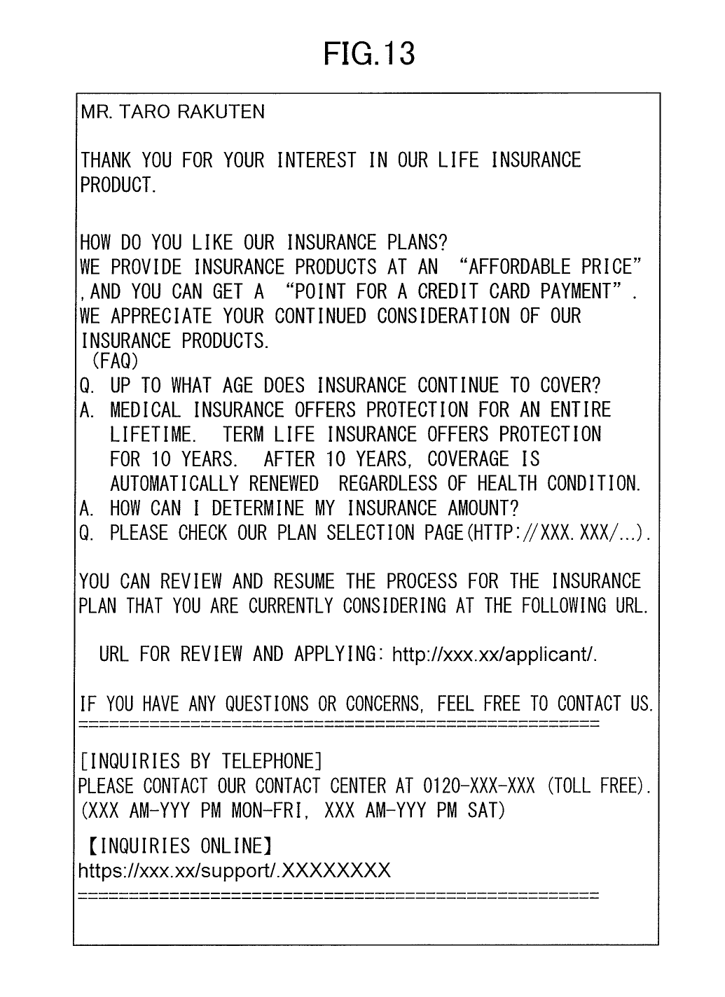

FIG. 13 illustrates an example of a reminder e-mail text. This text is an example of a reminder e-mail text that is sent when the last input screen in which the user enters information is a policyholder information input screen or a rider input screen. The text ID of this template text is “mail11”, and a section of the name “Taro Rakuten” in the template shows another character string indicating a place to be replaced with the user's name. As described above, in the early stage of procedure for applying insurance, a user highly likely contemplates whether to proceed with the application for the insurance, and thus a text of a reminder e-mail is mainly comprised of sentences to recommend the insurance product itself. In addition, the user may feel annoyed with a reminder e-mail that is sent soon after the user interrupted the input, and thus the e-mail is sent to the user after seven days has passed since the interruption of the input.

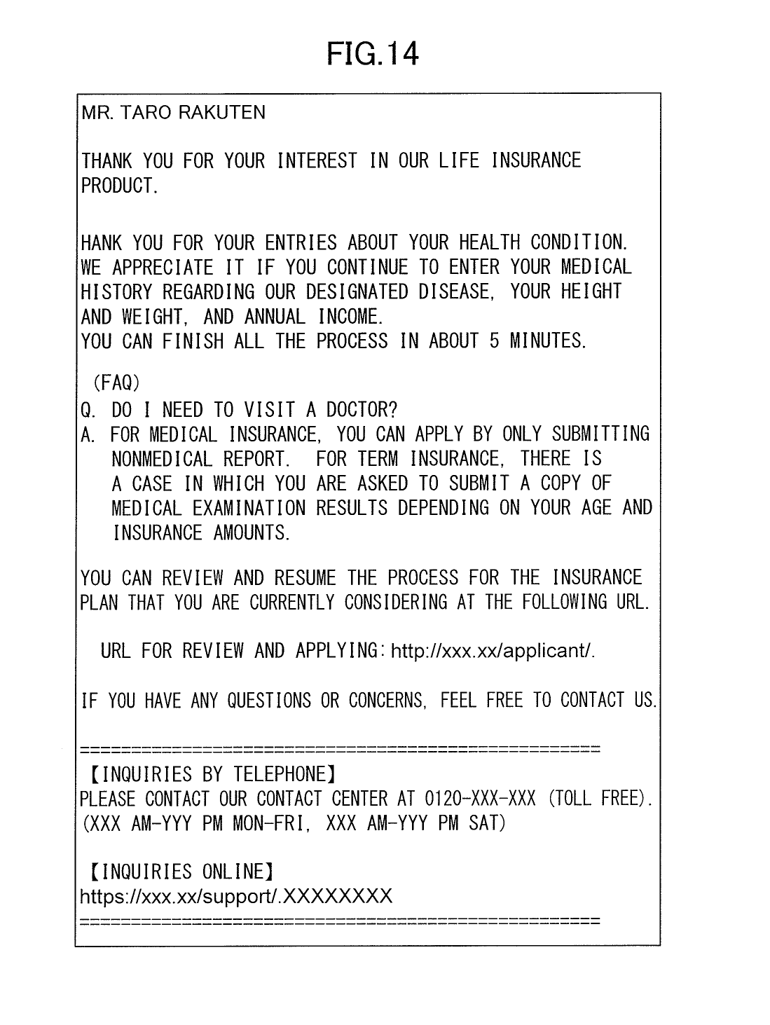

FIG. 14 illustrates another example of a reminder e-mail text. This text is an example of a reminder e-mail text that is sent when the last input screen in which the user enters information is a first health condition input screen or a second health condition input screen. The text ID of this template text is “mail13”, and sections of the name “Taro Rakuten” and “5 minutes” in the template show other character strings indicating places to be replaced with the user's name and the required input time. In a case where the user proceeds with entering information in the nonmedical report, the user highly likely applies for the insurance. As such, the text includes sentences that are not directed to explaining the insurance product, but to asking the user to continue entry of information or indicating answers to questions the user is likely to have at this stage of application. Further, as more time passes, the user is more likely to forget to apply for the insurance, a reminder e-mail is sent in a shorter period of time, such as one day, than the period of time shown in FIG. 13.

A large number of input screens are used to apply for insurance, and each input screen requests a user to enter different information. In view of such characteristics of insurance, it is effective to change a text of a reminder e-mail and a timing to send the e-mail depending on the proceeding of input screens. The reminder e-mail sending unit 54 may send a reminder e-mail including another text at the end of the previous month of the user's birthday.

When the user reads such reminder e-mails on the client device 2 and decides to resume the application procedure, the user opens the URL on the e-mail in order to resume the processing. The client device 2 then accesses the linked URL using a browser program, and obtains information of an input resuming screen from the insurance application server 1.

The input resuming unit 58 is implemented mainly by the processor 11, the storage unit 12, and the communication unit 13. When receiving an access from a user based on a reminder e-mail, for example, the input resuming unit 58 sends information of the input resuming screen for asking the user whether to resume the input procedure, and enables the user to resume entry in the input screen that is the earliest among the input screens in which entry is not made.

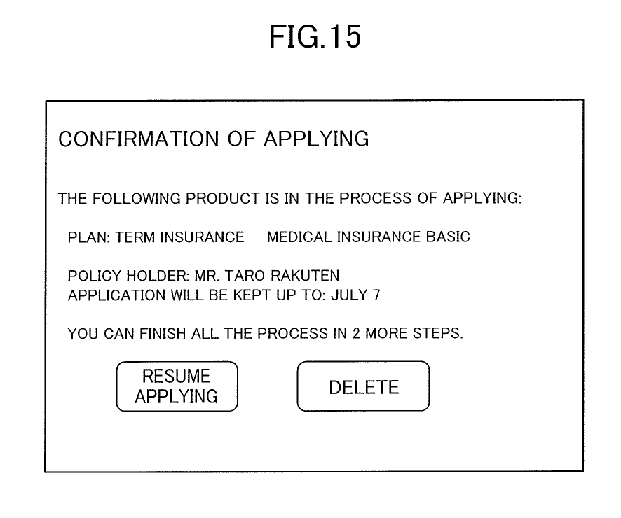

FIG. 15 illustrates an example of the input resuming screen. The input resuming screen displays information about the insurance product, for which the user has stopped the input operation in the middle, the date on which the application is interrupted, and the estimate of remaining work time. When the user presses a “Resume Applying” button and the input resuming unit 58 receives such information, the application input checking unit 52 is made to perform processing of the next input screen of the last input screen, in which the user made entries, and subsequent input screens. On the other hand, when the user presses “Delete” button, information of the user stored in the application information storing unit 61 is deleted. In this way, the user can skip the entered input screens to enter information in the rest of the input screens. This can reduce the user's input load compared to a case where the input operation cannot be resumed.

### REFERENCE SIGNS LIST

1 insurance application server, 2 client device, 3 network, 11 processor, 12 storage unit, 13 communication unit, 14 input/output unit, 33 applying button, 51 estimate unit, 52 application input checking unit, 53 application receiving unit, 54 reminder e-mail sending unit, 55 input screen presenting unit, 56 input obtaining unit, 57 input status storing unit, 58 input resuming unit, 61 application information storing unit, 62 e-mail setting storing unit.

1. An insurance application system comprising:
an input screen presenting unit for sequentially present a plurality of input screens, each having input items and being presented to an applicant;
an obtaining unit for obtaining information entered by the applicant in one of the input screens;
an input status storing unit for storing, in association with the applicant, input status information indicating an input screen, which is one of the input screens and in which the applicant has entered information, and a date and a time on which the applicant entered the information, based on the obtained information; and
a remind unit for sending, in a case where a remind time period has passed since a date and a time on which the applicant last entered information in one of the input screens, an e-mail including a reminder e-mail text according to a template text associated with the last input screen entered by the applicant, to an e-mail address of the applicant, based on the input status information and the date and the time associated with the applicant.

2. The insurance application system according to claim 1, wherein
the remind unit sends the e-mail including the reminder e-mail text to the e-mail address of the applicant in a case where a remind time period associated with the input screen, in which the applicant last entered information, has passed since the date and the time on which the applicant last entered information in the input screen.

3. The insurance application system according to claim 1, wherein
the remind unit obtains information indicating an input speed of the applicant based on a time on which the applicant enters information in each of the input screens, generates the reminder e-mail text further based on the information indicating the input speed, and sends the e-mail including the generated reminder e-mail text to the e-mail address of the applicant.

4. An insurance application method comprising:
sequentially presenting a plurality of input screens, each having input items and being presented to an applicant;
obtaining information entered by the applicant in one of the input screens;
storing, in association with the applicant, input status information indicating an input screen, which is one of the input screens and in which the applicant has entered information, and a date and a time on which the applicant entered the information, based on the obtained information; and
sending, in a case where a remind time period has passed since a date and a time on which the applicant last entered information in one of the input screens, an e-mail including a reminder e-mail text according to a template text associated with the last input screen entered by the applicant, to an e-mail address of the applicant, based on the input status information and the date and the time associated with the applicant.

5. (canceled)

6. A non-transitory computer-readable information storage medium that stores a program for causing a computer to execute:
sequentially presenting a plurality of input screens, each having input items and being presented to an applicant;
obtaining information entered by the applicant in one of the input screens;
storing, in association with the applicant, input status information indicating an input screen, which is one of the input screens and in which the applicant has entered information, and a date and a time on which the applicant entered the information, based on the obtained information; and
sending, in a case where a remind time period has passed since a date and a time on which the applicant last entered information in one of the input screens, an e-mail including a reminder e-mail text according to a template text associated with the last input screen entered by the applicant, to an e-mail address of the applicant, based on the input status information and the date and the time associated with the applicant.

7. The insurance application method according to claim 4, wherein
the e-mail including the reminder e-mail text is sent to the e-mail address of the applicant in a case where a remind time period associated with the input screen, in which the applicant last entered information, has passed since the date and the time on which the applicant last entered information in the input screen.

8. The insurance application method according to claim 4, further comprising:
obtaining information indicating an input speed of the applicant based on a time on which the applicant enters information in each of the input screens; and
generating the reminder e-mail text further based on the information indicating the input speed,
wherein the e-mail including the generated reminder e-mail text is sent to the e-mail address of the applicant.

9. The non-transitory computer-readable information storage medium according to claim 6, wherein
the e-mail including the reminder e-mail text is sent to the e-mail address of the applicant in a case where a remind time period associated with the input screen, in which the applicant last entered information, has passed since the date and the time on which the applicant last entered information in the input screen.

10. The non-transitory computer-readable information storage medium according to claim 6, wherein
the program causes the computer to further execute:
obtaining information indicating an input speed of the applicant based on a time on which the applicant enters information in each of the input screens; and
generating the reminder e-mail text further based on the information indicating the input speed,
wherein the e-mail including the generated reminder e-mail text is sent to the e-mail address of the applicant.
